(19) United States
(12) Patent Application Publication
(10) Pub. No.: US 2005/0090941 A1
(43) Pub. Date: Apr. 28, 2005

(54) Telematics based programming gateway

(75) Inventors: Jeffrey M. Stefan, Clawson, MI (US); Nathan D. Ampunan, West Bloomfield, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/691,281

(22) Filed: Oct. 22, 2003

(51) Int. Cl. G06F 19/00

(52) U.S. Cl. 701/1; 701/33

(57) ABSTRACT

A system and method for a telematics based programming gateway. A method describes initiating a vehicle field service software update, sending field service software update data to a vehicle telematics device from a telematics service center, receiving the field service software update data at the vehicle telematics device and providing the field software update data to at least one vehicle system from the vehicle telematics device wherein the at least one vehicle system is updated based on the field service software update data.

### FIELD OF THE INVENTION

The invention relates to vehicle design and manufacture, and more particularly to methods and systems for interactive vehicle design through the operation of a mobile of wireless communication enabled test vehicles within a wireless communication network.

### BACKGROUND OF THE INVENTION

Presently, many passenger vehicles, buses, trucks and the like, incorporate complex component vehicle systems. The application of very large scale integration components (VLSI) for processing and control functions permit the use of discrete computer controlled sub-systems within a vehicle to control many vital vehicle functions. Furthermore, many vehicles incorporate a vehicle system communication bus to permits bi-directional communication between the component systems of such a vehicle. One example of a computer controlled vehicle system is a power-train control module (PCM). The power-train control module for a vehicle typically controls combustion, engine timing and fuel mixture among other functions. Generally, each type of vehicle system control module incorporates application-specific software that executes various system functions and also operating parameters for the vehicle system. Each vehicle manufacturer integrates different functions into vehicle system modules. However, as each successive generation of control devices becomes more sophisticated the necessity for periodic in-field system service dramatically increases.

At present, in order to provide field service to various vehicle system modules, a vehicle must be brought to a qualified vehicle service facility and plugged into a specialized computing system to download software updates and new system parameters. However, the distribution of software updates, dedicated download computer systems and field technician training is expensive and requires an extensive infrastructure. Furthermore, a time-sensitive or system-critical update may be delayed if a customer is unaware of a system malfunction and the efficacy of the present field service regimen is suspect. The cost of dealership services, particularly for vehicles under warranty, must be absorbed into the cost of the vehicle to a consumer.

Many passenger vehicles now incorporate an integrated communication system. A Vehicle Communication Unit (VCU) used in conjunction with a Wide Area Network (WAN) such as a cellular telephone network or a satellite communication system allows for a variety of fee-based subscription services to be provided in a mobile environment. The VCU is typically a vehicle telematics device including a cellular radio, satellite transceiver and/or global positioning capabilities. Communication through a carrier service may be initiated at the VCU at turn-on or through manual or voice command phone number entry. Typically, a radio communication link is established between the VCU and a Wide Area Network (WAN), using a node of the WAN in the vicinity of the VCU.

In addition to enabling telecommunication services, a VCU may be configured to receive various types of data from a service provider. In some implementations, a VCU is also configured to provide various vehicle system information data to the service provider from the vehicle such as through a so-called vehicle data upload (VDU) operation. Such vehicle system information typically includes data such as service codes and error codes, for example.

It would be desirable therefore, to provide field service software updates to a mobile vehicle having a telematics device that overcomes these and other disadvantages.

### SUMMARY OF THE INVENTION

The present invention is directed to a method of providing field service software updates to a mobile vehicle having a telematics device. The method describes initiating a vehicle field service software update, sending field service software update data to a vehicle telematics device from a telematics service center, receiving the field service software update data at the vehicle telematics device and providing the field software update data to at least one vehicle system from the vehicle telematics device wherein the at least one vehicle system is updated based on the field service software update data.

In accordance with yet another aspect of the invention a computer readable medium includes computer readable code for initiating a vehicle field service software update, computer readable code for sending field service software update data to a vehicle telematics device from a telematics service center, computer readable code for storing received field service software update data at the vehicle telematics device, and computer readable code for providing the field software update data to at least one vehicle system from the vehicle telematics device wherein the at least one vehicle system is updated based on the field service software update data.

In accordance with still another aspect of the invention, a system for providing field service software updates to a mobile vehicle includes means for initiating a vehicle field service software update, means for sending field service software update data to a vehicle telematics device from a telematics service center, means for receiving the field service software update data at the vehicle telematics device and means for providing the field software update data to at least one vehicle system from the vehicle telematics device wherein the at least one vehicle system is updated based on the field service software update data.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustrative operating environment for a telematics based programming gateway in an embodiment of the present invention;

FIG. 2 is a block diagram of a telematics based programming gateway in accordance with an embodiment of the present invention;

FIG. 3 is a process flow diagram of a method for providing field service software updates to a mobile vehicle having a telematics device; and

FIG. 4 is a process flow diagram of a method for providing field service software updates to a mobile vehicle having a telematics device in another embodiment of the present invention.

### DETAILED DESCRIPTION OF THE PRESENTLY PREFERRED EMBODIMENT

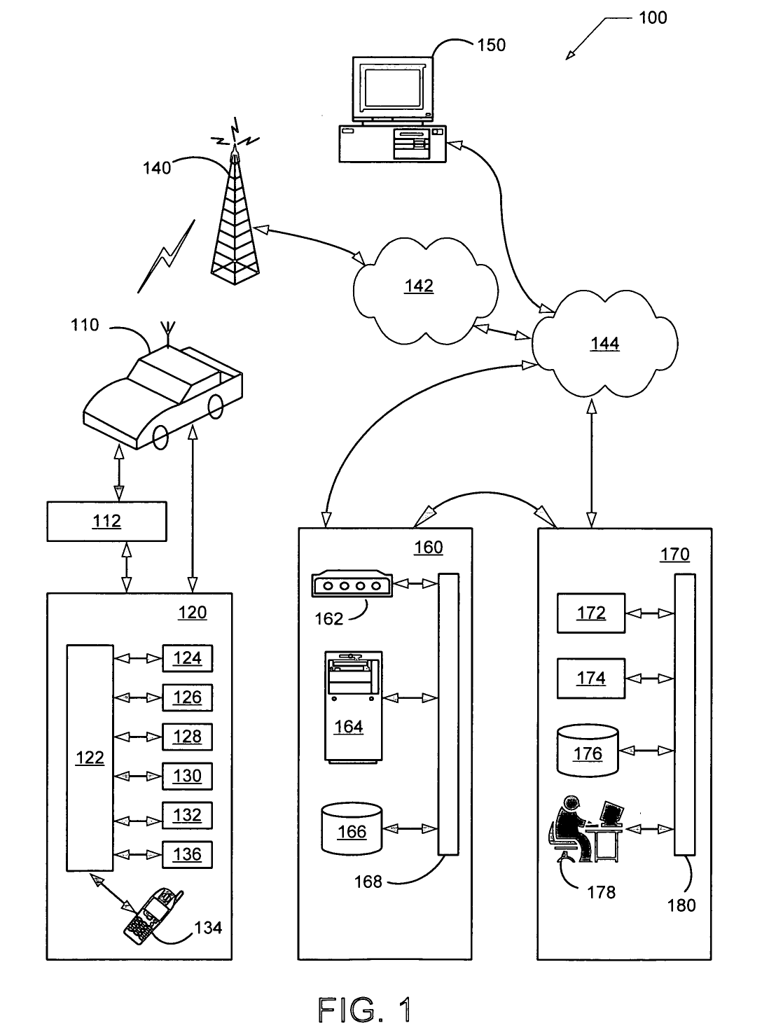

FIG. 1 is an illustrative operating environment for a telematics based programming gateway in an embodiment of the present invention. FIG. 1 shows a mobile vehicle communication system 100. Mobile communication system 100 includes at least one mobile vehicle 110 (vehicle, test vehicle) including vehicle communication bus 112 and vehicle communications unit (VCU) 120, one or more wireless carrier systems 140, one or more communication networks 142, one or more land networks 144, one or more client, personal or user computers 150, one or more web-hosting portals 160, and one or more call centers 170. In one embodiment, mobile vehicle 110 is implemented as a vehicle equipped with suitable hardware and software for transmitting and receiving voice and data communications.

In one embodiment, vehicle communications unit 120 is a telematics device that includes a digital signal processor (DSP) 122 connected to a wireless modem 124, a global positioning system (GPS) unit 126, an in-vehicle memory 128, such as, for example, a non-volatile flash memory, a microphone 130, one or more speakers 132, an embedded or in-vehicle mobile phone 134, and a wireless access point node 136. In one embodiment, DSP 122 is a microcontroller, controller, host processor, or vehicle communications processor. In an example, DSP 122 is implemented as an application specific integrated circuit (ASIC). GPS unit 126 provides longitude and latitude coordinates of the vehicle, as well as a time stamp. In-vehicle mobile telephone system 134 is a cellular-type phone, such as, for example an analog, digital, dual-mode, dual-band, multi-mode or multi-band cellular phone. In another example, the mobile telephone system is an analog mobile telephone system operating over a prescribed band nominally at 800 MHz. In another example, the mobile telephone system is a digital mobile telephone system operating over a prescribed band nominally at 800 MHz, 900 MHz, 1900 MHz, or any suitable band capable of carrying digital cellular communications.

DSP 122 executes various computer programs and communication control and protocol algorithms that control communication, programming and operational modes of electronic and mechanical systems within test vehicle 110. In one embodiment, DSP 122 is an embedded system controller. In another embodiment, DSP 122 controls communications between telematics device 120, wireless carrier system 140, and call center 170. In another embodiment, DSP 122 controls communications between the wireless access point node 134 and nodes of a mobile ad hoc network. In one embodiment, a voice-recognition application is installed in DSP 122 to translate human voice input through microphone 130 into digital signals. DSP 122 generates and accepts digital signals transmitted between telematics device 120 and a vehicle communication bus 112 that is connected to various electronic modules in the vehicle 110. In one embodiment, the digital signals activate a programming mode and operation modes, as well as provide for data transfers. In another embodiment, a vehicle data upload (VDU) utility program facilitates the transfer of instructions and data requests to vehicle 110 and field service software update data.

Mobile vehicle 110, via a vehicle communication bus 112, sends signals to various units of equipment and systems within test vehicle 110 to perform various functions such as monitoring the operational state of vehicle systems, collecting and storing data from the vehicle systems, providing instructions, data and programs to various vehicle systems and calling from telematics device 120. In facilitating interactions among the various communication and electronic modules, vehicle communication bus 112 utilizes bus interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) standard J1850 for higher and lower speed applications. In one embodiment, vehicle communication bus 112 is a direct connection between connected devices.

Test vehicle 110, via telematics device 120, sends and receives radio transmissions from wireless carrier system 140. Wireless carrier system 140 is implemented as any suitable system for transmitting a signal from mobile vehicle 110 to communication network 142. Wireless carrier system 140 incorporates any type of telecommunications in which electromagnetic waves carry signal over part of or the entire communication path. In one embodiment, wireless carrier system 140 transmits analog audio and/or video signals. In an example, wireless carrier system 140 transmits analog audio and/or video signals such as those sent from AM and FM radio stations and transmitters, or digital audio signals in the S band (approved for use in the U.S.) and L band (used in Europe and Canada). In one embodiment, wireless carrier system 140 is a satellite broadcast system broadcasting over a spectrum in the “S” band (2.3 GHz) that has been allocated by the U.S. Federal Communications Commission (FCC) for nationwide broadcasting of satellite-based Digital Audio Radio Service (DARS).

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to mobile vehicle 110 and land network 144. In one example, wireless carrier system 140 includes a short message service, modeled after established protocols such as IS-637 SMS standards, IS-136 air interface standards for SMS, and GSM 03.40 and 09.02 standards. Similar to paging, an SMS communication could be broadcast to a number of regional recipients. In another example, the carrier system 140 uses services in accordance with other standards, such as, for example, IEEE 802.11 compliant wireless systems and Bluetooth compliant wireless systems.

Land network 144 is a public-switched telephone network (PSTN). In one embodiment, land network 144 is implemented as an Internet protocol (IP) network. In other embodiments, land network 144 is implemented as a wired network, an optical network, a fiber network, another wireless network, or any combination thereof. Land network 144 is connected to one or more landline telephones. Land network 144 connects communication network 142 to user computer 150, web-hosting portal 160, and call center 170. Communication network 142 and land network 144 connects wireless carrier system 140 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160 and test vehicle 110. Personal or user computer 150 sends vehicle software update requests or field service software update data to web-hosting portal through a web-page interface using communication standards such as hypertext transport protocol (HTTP), and transport-control protocol Internet protocol (TCP/IP). In one embodiment, the data includes directives to change certain programming and operational modes of electronic and mechanical systems within test vehicle 110. In another embodiment, the data includes executable code to reprogram certain functions such as operational modes of electronic and mechanical systems within test vehicle 110. In operation, a user, such as, for example, a vehicle designer or manufacturing engineer, utilizes user computer 150 to provide requests to perform vehicle software update requests or field service software update data to mobile vehicle 110 that is cached or stored in web-hosting portal 160. In an embodiment, mobile vehicle data from client-side software is transmitted to server-side software of web-hosting portal 160. In one embodiment, vehicle software update request data is stored at web-hosting portal 160. In another embodiment, client computer 150 includes a database (not shown) for storing received field service software update data. In yet another embodiment, a private Local Area Network (LAN) is implemented for client computer 150 and Web hosting portal 160, such that web hosting portal is operated as a Virtual Private Network (VPN).

Web-hosting portal 160 includes one or more data modems 162, one or more web servers 164, one or more databases 166, and a network 168. Web-hosting portal 160 is connected directly by wire to call center 170, or connected by phone lines to land network 144, which is connected to call center 170. Web-hosting portal 160 is connected to land network 144 by one or more data modems 162. Land network 144 sends digital data to and from modem 162; data that is subsequently transferred to web server 164. In one implementation, modem 162 resides inside web server 164. Land network 144 transmits data communications between web-hosting portal 160 and call center 170.

Web server 164 receives various data, requests or instructions from user computer 150 via land network 144. In alternative embodiments, user computer 150 includes a wireless modem to send data to web-hosting portal 160 through a wireless communication network 142 and a land network 144. Data is received by modem 162 and sent to one or more web servers 164. In one embodiment, web server 164 is implemented as any suitable hardware and software capable of providing web services to transmit and receive data from user computer 150 to telematics device 120 in test vehicle 110. Web server 164 sends to or receives data transmissions from one or more databases 166 via network 168. Web server 164 includes computer applications and files for managing mobile data.

In one embodiment, one or more web servers 164 are networked via network 168 to distribute field service software update data among its network components such as database 166. In an example, database 166 is a part of or a separate computer from web server 164. In one embodiment, web-server 164 sends data transmissions with mobile data to call center 170 via modem 162, and through land network 144.

Call center 170 is a location where many calls are received and serviced at the same time, or where many calls are sent at the same time. In one embodiment, the call center is a telematics call center, facilitating communications to and from telematics device 120 in test vehicle 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more networks 180.

Switch 172 of call center 170 connects to land network 144. Switch 172 transmits voice or data transmissions from call center 170, and receives voice or data transmissions from telematics device 120 in mobile vehicle 110 through wireless carrier system 140, wireless access point node 136 or both, communication network 142, and land network 144. Switch 172 receives data transmissions from, and sends data transmissions to, one or more web-hosting portals 160. Switch 172 receives data transmissions from, or sends data transmissions to, one or more communication services managers 174 via one or more networks 180.

Communication services manager 174 is any suitable hardware and software capable of providing communication services to telematics device 120 in mobile vehicle 110. Communication services manager 174 sends to or receives data transmissions from one or more communication services databases 176 via network 180. Communication services manager 174 sends to or receives data transmissions from one or more communication services advisors 178 via network 180. Communication services database 176 sends to or receives data transmissions from communication services advisor 178 via network 180. Communication services advisor 178 receives from or sends to switch 172 voice or data transmissions.

Communication services manager 174 facilitates one or more services, such as, but not limited to, enrollment services, navigation assistance, directory assistance, roadside assistance, business or residential assistance, information services assistance, emergency assistance, and communications assistance and vehicle software update management services. Communication services manager 174 receives service requests for a vehicle software update and field service software update data from a user via user computer 150, web-hosting portal 160, and land network 144. Communication services manager 174 transmits and receives operational status, instructions and other types of vehicle data to telematics device 120 in mobile vehicle 110 through wireless carrier system 140, communication network 142, land network 144, wireless access point node 136 voice and data switch 172, and network 180. Communication services manager 174 stores or retrieves field service software update data from communication services database 176. Communication services manager 174 provides requested information to communication services advisor 178.

In one embodiment, communication services advisor 178 is a real advisor. In another embodiment, communication services advisor 178 is implemented as a virtual advisor. In an example, a real advisor is a human being at service provider service center in verbal communication with service subscriber in mobile vehicle 110 via telematics device 120. In another example, a virtual advisor is implemented as a synthesized voice interface responding to requests from telematics device 120 in mobile vehicle 110. In another embodiment, communication services advisor 178 is embodied in software executing on a computing system, and provided automated field service functions, such as managing field service software update data.

Communication services advisor 178 provides services to telematics device 120 in mobile vehicle 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicates with telematics device 120 in mobile vehicle 110 through wireless carrier system 140, communication network 142, and land network 144 using voice transmissions, or through communication services manager 174 and switch 172 using data transmissions. Switch 172 selects between voice transmissions and data transmissions.

Mobile vehicle 110 initiates service requests to call center 170 by sending a voice or digital-signal command to telematics device 120 which in turn, sends an instructional signal or a voice call through wireless modem 124, wireless carrier system 140, communication network 142, and land network 144 to call center 170. In another embodiment, the service request is for a vehicle data upload (VDU) that initiates a data transfer between test vehicle 110 and service center 170 or web hosting portal 160. In another embodiment, the mobile vehicle 110 receives a request from call center 170 to send various vehicle data from mobile vehicle 110 through telematics device 120 through wireless modem 124, wireless access point node 136, wireless carrier system 140, communication network 142, and land network 144 to call center 170. In one embodiment, one or more triggers stored in the telematics device 120 cause the test vehicle to initiate a service request. The trigger is, for example, a number of ignition cycles, a specific time and date, an expired time, a number of kilometers, a request for a vehicle software update and the like.

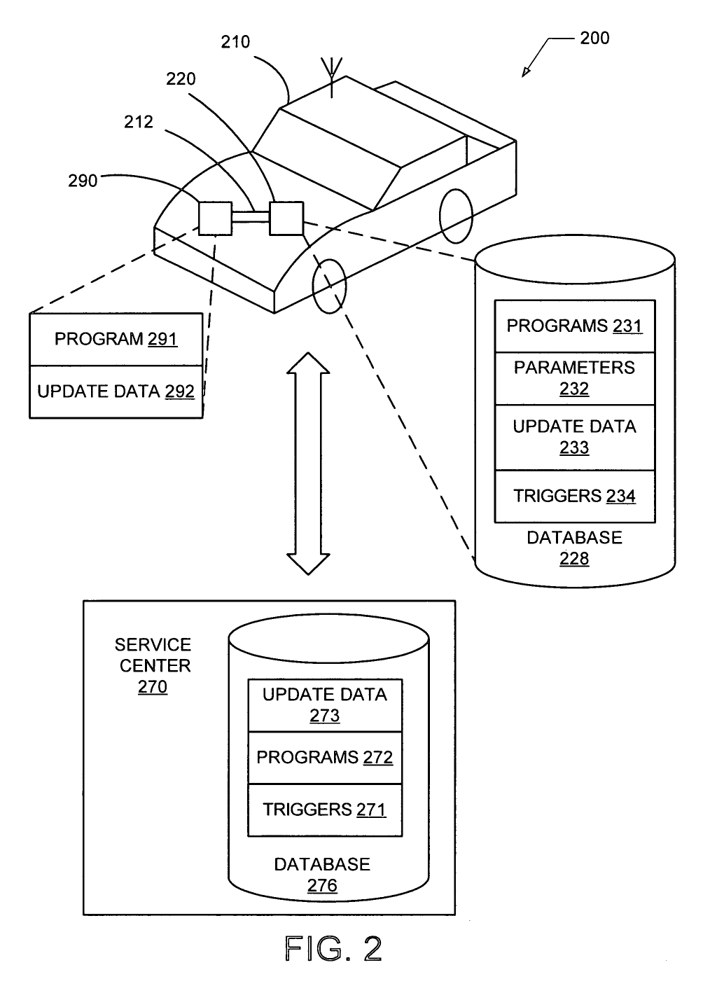

FIG. 2 is a block diagram of an exemplary telematics based programming gateway in accordance with an embodiment of the present invention. FIG. 2 shows a telematics based programming gateway system 200 for providing field service software updates to a mobile vehicle. In one embodiment, the components of telematics based programming gateway system 200 are operational within an illustrative operating environment as described in FIG. 1.

In FIG. 2, the programming gateway system 200 includes a telematics service center 270, and a mobile vehicle 210 having a telematics device 220 that is coupled to one or more vehicle system modules 290 via a communication bridge 212. The telematics device 220 is shown including a database 228 that contains programs 231, parameters 232, update data 233 and event triggers 234. The vehicle system module 290 is shown including a program 291 and update data 292. The service center 270 is shown including a database 276 containing update data 273, programs 272, and event triggers 271. The telematics service center is shown in communication with the telematics device 220 in vehicle 210. In one embodiment, communications bus 212 coupling telematics device 220 to vehicle system modules 290 is a direct connection between the connected devices. In another embodiment, communications bus 212 is a vehicle communication bus 112 as described in FIG. 1.

Mobile vehicle 210 is any type of vehicle including a passenger vehicle, bus, truck and the like, that includes integrated vehicle system modules and a telematics device. In one embodiment, vehicle 210 and various systems of vehicle 210 are uniquely identifiable via an assigned identification code such as, for example, a vehicle identification number (VIN) or a device identification code of a vehicle system module 290 or telematics device 220.

Telematics device 220 is any telematics device enabled for operation with a telematics service provider such as telematics device 120 as described with reference to FIG. 1. In one embodiment, telematics device 220 is coupled to vehicle communication bus 212 for communicating data between vehicle system modules 290 and the telematics device 220. Telematics device 220 includes volatile and non-volatile memory components for storing data and programs. In one embodiment, memory components in telematics device 220 contain database 228. In an embodiment, database 228 includes one or more programs 231 for managing software update processes, such as, for example, an update program module, and other programs 231 for detecting software update requests and the like. An update program module applies any field service update data 233 received to the telematics device 220 to update a vehicle system's software or operational parameters 232. In still another embodiment, the telematics device 220 acts as a data cache for update data 233, caching any received update data that is provided to a vehicle system module 290 for the telematics device.

Vehicle system module 290 (VSM, vehicle system, module) is any vehicle system control module having software and hardware components for operating, controlling or monitoring one or more vehicle systems. In one embodiment, vehicle system module 290 is a vehicle system controller such as, for example, a power train control module (PCM). In another embodiment, vehicle system module 290 contains one or more processors, one or more memory devices and one or more connection ports for communicating data to and from the VSM 290. In an embodiment, VSM 290 is coupled to a vehicle communication bus 212, and therefore to any other device that is also coupled to vehicle communication bus 212. In another embodiment, VSM 290 is connected directly to telematics device 220. In an embodiment, VSM 290 includes stored in memory, one or more programs 291 and update data 292. In one embodiment, program 291 includes for managing software update processes, such as, for example, an update program module. An update program module applies any field service update data 292 received to the VSM 290 from the telematics device 220 to update software or operational parameters of VSM 292.

Telematics service center 270 is any service center providing telematics services such as service center 170 described with reference to FIG. 1. In one embodiment, service center 270 includes hardware and software for managing a field service software update database 276. In another embodiment, service center 270 is configured to access a database that is in another location but coupled to service center 270 such as, for example, database 166 in web server 160 as described in FIG. 1. In an embodiment, database 276 contains records of vehicle system module updates. In an embodiment, database 276 includes one or more programs for managing vehicle update data, for managing software update processes for various vehicle systems, for responding to vehicle software update requests, and for detecting a field service software update trigger event. In another embodiment, database 276 is a relational database that includes information such as, for example, vehicle makes and models, vehicle system modules for the makes and models, individual vehicle identification numbers (VIN) and other vehicle identifiers, vehicle system software updates including vehicle system parameters and executable code, and trigger event data specifying conditions for field service software updates. The trigger is, for example, a number of ignition cycles, a specific time and date, an expired time, a number of kilometers, a request for a vehicle software update and the like.

In operation, service center 270 manages the compilation and delivery of VSM 290 field service software update data through a telematics service provider network such as the operating environment described in FIG. 1. In an embodiment, service center 270 is enabled to concatenate, and otherwise manage, software update data for vehicle 210 provided from multiple sources. In operation, service center 270 receives software and parameter upgrade data and associates the data with vehicle 210 in database 276. A trigger event such as, for example, the expiration of a periodic time interval or a request or a software update from a maintenance team or from vehicle 210 initiates an in-field software update for a VSM 290 of vehicle 210. Software update data is provided to service center 270 from one or more client sources, such as, for example, an engineering center. In an embodiment, field service software update data is provided from the service center 270 to the telematics device 220 of mobile vehicle 210 based on a vehicle software update request. In one embodiment, the vehicle software update request is from a vehicle telematics device 220. In another embodiment, the vehicle software update request is from a service center 270.

In an embodiment, service center database 276 contains a relational database that includes identifiers for makes and model of vehicles and the vehicle system modules associated with the vehicle types. In one embodiment, the database 276 includes a list of specific vehicle identifiers, such as vehicle identification numbers, that catalogues specific vehicles in operation in the field. In another embodiment, the list of identified vehicles includes records of any field services that have been performed on each vehicle of the list. Therefore, a record of field services of any particular vehicle is maintained by the database. In yet another embodiment, various records applicable to field service software update data are distributed among several interconnected databases that are operably coupled to one another. In yet another embodiment, field service update data such as that stored in database 276 and database 228 is programs and other executable routines, vehicle system operating parameters, various event triggers such update event triggers, and software module lists.

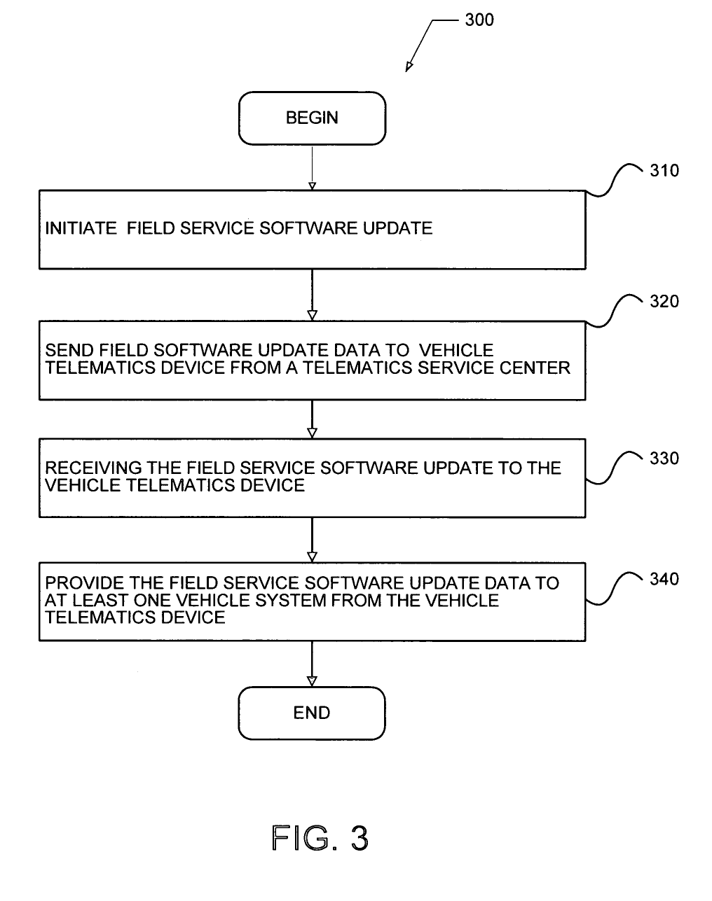

FIG. 3 is a process flow diagram of a method for providing field service software updates to a mobile vehicle having a telematics device. In one embodiment, method 300 is implemented with components of the exemplary systems described with reference to FIGS. 1 and 2. In another embodiment, one or more steps of method 300 are embodied in a computer readable medium containing computer readable code. In yet another embodiment, computer readable code Method 300 begins in step 310. In step 310, a vehicle field service software update is initiated. In one embodiment, the field service software update occurs at any time that a mobile vehicle 210 is operational within a telematics based programming gateway system 200 for providing field service software updates to a mobile vehicle.

In an embodiment, initiating a field service software update for a vehicle comprises identifying a vehicle for updating, associating field service software update data with at least one vehicle system of the identified vehicle, and providing the field service software update data to a telematics service center for delivery to the identified vehicle responsive to a vehicle software update request for the identified vehicle. In one embodiment, the steps of identifying a vehicle for updating and associating field service software update data with at least one vehicle system of the identified vehicle occur at a different time than the step of providing the field service software update data to a telematics service center.

In one embodiment, the vehicle telematics device provides a vehicle software update request responsive to detecting a field service software update trigger event. In another embodiment, the telematics service center provides a vehicle software update request responsive to detecting a field service software update trigger event. In yet another embodiment, a service center compiles software update data for one or more vehicle systems in a relational database that is accessed to provide field service software update data to specific makes and models of vehicles. In one embodiment, a database at a service center contains a record for each of a plurality of mobile vehicles in operation in the field by identifying the vehicle in the record with a unique identification code such as a vehicle identification number. In another embodiment, a vehicle system of a specific vehicle is identified in a vehicle record with a unique device identification code such as is known in the art. In still another embodiment, a record of field service software updates provided to a specific vehicle is accessed and updated each time that a field service software update is initiated for an identified vehicle.

In step 320, field service software update data is sent to a vehicle telematics device from a telematics service center. The field service software update data is sent at any time after completion of step 310. In one embodiment, one or more components of the exemplary system of FIG. 1 are employed to send the field service software update data to the vehicle telematics device, such as, for example, a service provider, a public-switched telephone network (PSTN), and a wireless carrier.

In step 330, the field service software update data is received at the vehicle telematics device. The field service software update data is received at any time after it is sent in step 320. One embodiment further comprises storing the field software update data at the vehicle telematics device responsive to receiving the update data. In still another embodiment, storing the field software update data includes caching the data in temporary storage or memory devices. In still another embodiment, field software update data is parsed for different content, such as, for example, executable routines, event triggers, device and system identification lists, and systems parameters, and each data type is stored in a memory location based on the data type.

In step 340, the field service software update data is provided to at least one vehicle system from the vehicle telematics device. In an embodiment, the at least one vehicle system is updated based on the field service software update data. In another embodiment, providing the field service software update data to at least one vehicle system from the vehicle telematics device comprises detecting a vehicle system update trigger event at the telematics device, accessing an update program module stored at the vehicle telematics device responsive to the detecting, and invoking the update program module wherein the update program module applies the received field service software update data to update the at least one vehicle system. In this embodiment, the telematics device operates as a control unit for updating or reprogramming a vehicle system in response to an update trigger event. Again, in this embodiment, one or more update program modules are resident in memory in the telematics device to provide the update function to one or more vehicle system modules.

In another embodiment, providing the field service software update data to at least one vehicle system from the vehicle telematics device comprises detecting vehicle system update trigger event at the telematics device, accessing the received field service software update data, and applying the received field service update data to the at least one vehicle system to update the at least one vehicle system. In yet another embodiment, the at least one vehicle system includes executable code for performing the updating. In still another embodiment, executable code for performing the updating is included with the received field service update data. In an embodiment, the telematics device operates as a field service software data router system that receives and caches the data for application to one or more vehicle systems as the data is received, or at a later time. In one embodiment, an update event trigger causes a telematics device to request a vehicle software update from a service provider, which results in the telematics device receiving field service software update data that is applied to a vehicle system.

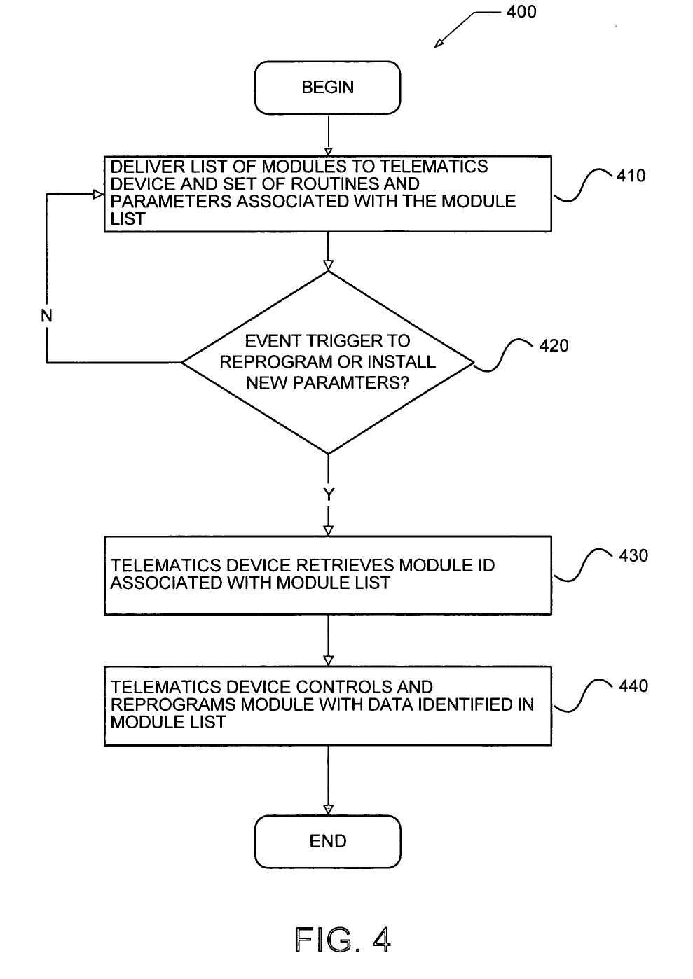

FIG. 4 is a process flow diagram of a method for providing field service software updates to a mobile vehicle having a telematics device (unit) in another embodiment of the present invention. In one embodiment, method 400 is implemented with components of the exemplary systems described with reference to FIGS. 1 and 2. In another embodiment, one or more steps of method 400 are embodied in a computer readable medium containing computer readable code. Method 400 begins in step 410. In step 410, data including a module list and routines and parameters associated with the module list is delivered to a telematics device. In one embodiment, the module list is a list of vehicle system modules in the vehicle receiving the list. In an embodiment, the data is delivered to a telematics device from a service center in response to a vehicle software update request for an identified vehicle. In another embodiment, event triggers are received and stored at the telematics device that when detected, initiate software maintenance functions, such as reprogramming or installing new parameters to a module.

In step 420, a determination is made if an event trigger is detected to reprogram or install new parameters to a module. When the determination in step 420 is false, or no, method 400 returns to step 410. When the determination in step 420 is true or yes, method 400 continues to step 430.

In step 430, the telematics device retrieves the module identification associated with the module list and the event trigger. The module identification (ID) is any identifier such as, for example, an electronic serial number (ESN) or another identifier as is known in the art. The module ID correlates data and parameters that are associated with an update of the identified module.

In step 440, the telematics device controls the reprogramming of the module data identified in step 430. In one embodiment, method 400 returns to step 420 once step 440 is completed. In another embodiment, method 400 terminates once step 440 is completed.

It is anticipated that the invention will be embodied in other specific forms not described that do not depart from its spirit or essential characteristics. The described embodiments are to be considered in all respects only as illustrative and not restrictive.

1. A method of providing field service software updates to a mobile vehicle having a telematics device comprising:
initiating a vehicle field service software update;
sending field service software update data to a vehicle telematics device from a telematics service center;
receiving the field service software update data at the vehicle telematics device; and
providing the field service software update data to at least one vehicle system from the vehicle telematics device wherein the at least one vehicle system is updated based on the field service software update data.

2. The method of claim 1 wherein initiating a vehicle field service software update for a vehicle comprises:
identifying a vehicle for updating;
associating field service software update data with at least one vehicle system of the identified vehicle; and
providing the field service software update data to a telematics service center for delivery to the identified vehicle responsive to a vehicle software update request for the identified vehicle.

3. The method of claim 2 wherein the vehicle telematics device provides a vehicle software update request responsive to detecting a field service software update trigger event.

4. The method of claim 2 wherein the telematics service center provides a vehicle software update request responsive to detecting a field service software update trigger event.

5. The method of claim 1 further comprising:
storing the field service software update data at the vehicle telematics device.

6. The method of claim 1 wherein providing the field service software update data to at least one vehicle system from the vehicle telematics device comprises:
detecting a field service software update trigger event at the telematics device;
accessing an update program module stored at the vehicle telematics device responsive to the detecting; and
invoking the update program module wherein the update program module applies the received field service update data to update the at least one vehicle system.

7. The method of claim 1 wherein providing the field service software update data to at least one vehicle system from the vehicle telematics device comprises:
detecting a field service software update trigger event at the telematics device;
accessing the received field service update data;
applying the received field service update data to the at least one vehicle system to update the at least one vehicle system.

8. The method of claim 7 wherein the at least one vehicle system includes executable code for performing the updating.

9. The method of claim 7 wherein executable code for performing the updating is included with the received field service update data.

10. The method of claim 1 wherein the field service update data includes data selected from the group consisting of:
vehicle system parameters, executable routines, update event triggers, and software module lists.

11. A computer readable medium storing a computer program comprising:
computer readable code for initiating a vehicle field service software update;
computer readable code for sending field service software update data to a vehicle telematics device from a telematics service center;
computer readable code for storing received field service software update data at the vehicle telematics device; and
computer readable code for providing the field service software update data to at least one vehicle system from the vehicle telematics device wherein the at least one vehicle system is updated based on the field service software update data.

12. The computer readable medium of claim 11 wherein code for initiating a vehicle field service software update comprises:
computer readable code for identifying a vehicle for updating;
computer readable code for associating field service software update data with at least one vehicle system of the identified vehicle; and
computer readable code for providing the field service software update data to a telematics service center for delivery to the identified vehicle responsive to a vehicle software update request for the identified vehicle.

13. The computer readable medium of claim 11 wherein computer readable code for providing the field service software update data to at least one vehicle system from the vehicle telematics device comprises:
computer readable code for detecting a field service software update trigger event at the telematics device;
computer readable code for accessing an update program module stored at the vehicle telematics device responsive to the detecting; and
computer readable code for invoking the update program module wherein the update program module applies the received field service update data to update the at least one vehicle system.

14. The computer readable medium of claim 11 wherein code for providing the field service software update data to at least one vehicle system from the vehicle telematics device comprises:
computer readable code for detecting a field service software update trigger event at the telematics device;
computer readable code for accessing the received field service update data;
computer readable code for applying the received field service update data to the at least one vehicle system to update the at least one vehicle system.

15. The computer readable medium of claim 14 wherein the at least one vehicle system includes a computer readable medium having computer readable code for performing the updating when executed.

16. The computer readable medium of claim 14 wherein computer readable code for performing the updating is included with the received field service update data.

17. A system for providing field service software updates to a mobile vehicle comprising comprising:
means for initiating a vehicle field service software update;
means for sending field service software update data to a vehicle telematics device from a telematics service center;
means for receiving the field service software update data at the vehicle telematics device; and
means for providing the field service software update data to at least one vehicle system from the vehicle telematics device wherein the at least one vehicle system is updated based on the field service software update data.
